(19) United States
(12) Patent Application Publication
(10) Pub. No.: US 2022/0055615 A1
(43) Pub. Date: Feb. 24, 2022

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Ryoichi Inoue, Wako-shi (JP); Etsuo Watanabe, Tokyo (JP)

(21) Appl. No.: 17/405,210

(22) Filed: Aug. 18, 2021

(30) Foreign Application Priority Data
Aug. 24, 2020 (JP) 2020-140617

(51) Int. Cl. B60W 30/09; B60W 30/095; B60W 60/00; G06K 9/00; B60W 10/18

(52) U.S. Cl. CPC B60W 30/09; B60W 30/0956; B60W 60/0015; B60W 2554/4041; B60W 10/18; B60W 2552/53; G06K 9/00798

(57) ABSTRACT

According to an embodiment, a vehicle control device includes a recognizer configured to recognize surroundings of a host vehicle, and an avoidance controller configured to able to execute first avoidance control for avoiding contact with a physical object recognized by the recognizer according to braking of the host vehicle and second avoidance control for avoiding the contact with the physical object recognized by the recognizer according to movement of the host vehicle in a vehicle width direction. When the contact between the host vehicle and the physical object is avoided, the avoidance controller selects either the first avoidance control or the second avoidance control on the basis of a lane type of a host vehicle lane recognized by the recognizer and preferentially executes the selected avoidance control.

### CROSS-REFERENCE TO RELATED APPLICATION

Priority is claimed on Japanese Patent Application No. 2020-140617, filed Aug. 24, 2020, the content of which is incorporated herein by reference.

### BACKGROUND

### Field of the Invention

The present invention relates to a vehicle control device, a vehicle control method, and a storage medium.

### Description of Related Art

In recent years, research has been conducted on automatically controlling the traveling of vehicles. In relation to this, there is known technology associated with a traveling control device for executing first control for controlling the movement of a host vehicle in a vehicle width direction on the basis of a position of an avoidance target when the avoidance target of which contact with the host vehicle is to be avoided is present and second control for controlling braking of the host vehicle on the basis of a traveling state of a preceding vehicle when the preceding vehicle is present (for example, Japanese Unexamined Patent Application, First Publication No. 2016-37267).

### SUMMARY

However, in the conventional technology, avoidance control based on a situation of a road on which a host vehicle travels has not been taken into account. Therefore, appropriate avoidance control may not be executed.

Aspects of the present invention have been made in consideration of such circumstances and an objective of the present invention is to provide a vehicle control device, a vehicle control method, and a storage medium capable of executing more appropriate avoidance control.

A vehicle control device, a vehicle control method, and a storage medium according to the present invention adopt the following configurations.

(1): According to an aspect of the present invention, there is provided a vehicle control device including: a recognizer configured to recognize surroundings of a host vehicle; and an avoidance controller configured to be able to execute first avoidance control for avoiding contact with a physical object recognized by the recognizer according to braking of the host vehicle and second avoidance control for avoiding the contact with the physical object recognized by the recognizer according to movement of the host vehicle in a vehicle width direction, wherein, when the contact between the host vehicle and the physical object is avoided, the avoidance controller selects either the first avoidance control or the second avoidance control on the basis of a lane type of a host vehicle lane recognized by the recognizer and preferentially executes the selected avoidance control.

(2): In the above-described aspect (1), the avoidance controller preferentially executes the second avoidance control when the host vehicle lane is a lane where a lane change to an adjacent lane adjacent to the host vehicle lane is possible, and preferentially executes the first avoidance control when the host vehicle lane is a lane where a lane change is prohibited, on the basis of the lane type.

(3): In the above-described aspect (2), the avoidance controller preferentially executes the first avoidance control when the host vehicle lane is the lane where a lane change is possible and another vehicle is present in the adjacent lane to which the host vehicle moves according to the second avoidance control.

(4): In the above-described aspect (3), the avoidance controller executes the second avoidance control when the other vehicle is at a predetermined distance or more from the host vehicle after preferentially executing the first avoidance control.

(5): In the above-described aspect (2), the avoidance controller executes the second voidance control after executing the first avoidance control when the host vehicle lane is a lane where a lane change is prohibited and the prohibition of the lane change will be lifted in the near future. (6): In the above-described aspect (2), the avoidance controller preferentially executes the first avoidance control when the host vehicle lane is the lane where a lane change is possible and will change to a lane where a lane change is prohibited in the near future.

(7): According to an aspect of the present invention, there is provided a vehicle control method including: recognizing, by a computer, surroundings of a host vehicle; executing, by the computer, first avoidance control for avoiding contact with a recognized physical object according to braking of the host vehicle and second avoidance control for avoiding the contact with the physical object according to movement of the host vehicle in a vehicle width direction; and selecting, by the computer, either the first avoidance control or the second avoidance control on the basis of a recognized lane type of a host vehicle lane when the contact between the host vehicle and the physical object is avoided and preferentially executing the selected avoidance control.

(8): According to an aspect of the present invention, there is provided a computer-readable non-transitory storage medium storing a program for causing a computer to: recognize surroundings of a host vehicle; execute first avoidance control for avoiding contact with a recognized physical object according to braking of the host vehicle and second avoidance control for avoiding the contact with the physical object according to movement of the host vehicle in a vehicle width direction; and select either the first avoidance control or the second avoidance control on the basis of a recognized lane type of a host vehicle lane when the contact between the host vehicle and the physical object is avoided and preferentially execute the selected avoidance control.

According to the above-described aspects (1) to (8), it is possible to execute more appropriate avoidance control.

### BRIEF DESCRIPTION OF THE DRAWINGS

FIG. 1 is a configuration diagram of a vehicle system including a vehicle control device according to an embodiment.

FIG. 2 is a functional configuration diagram of a first controller and a second controller.

FIG. 3 is a diagram for describing a recognizer and an action plan generator.

FIG. 4 is a diagram for describing avoidance control in a situation in which there is a following vehicle in an adjacent lane.

FIG. 5 is a diagram for describing avoidance control in a situation in which a host vehicle M travels in a lane change prohibition section.

FIG. 6 is a diagram (part 1) for describing avoidance control in a situation in which a host vehicle lane changes from a lane change prohibition section to an available lane change section.

FIG. 7 is a diagram (part 2) for describing avoidance control in a situation in which a host vehicle lane changes from a lane change prohibition section to an available lane change section.

FIG. 8 is a diagram for describing avoidance control in a situation in which a change from an available lane change section to a lane change prohibition section is made.

FIG. 9 is a flowchart showing an example of a flow of a process executed by an automated driving control device of the embodiment.

FIG. 10 is a diagram showing an example of a functional configuration of a vehicle system including a driving assistance device.

FIG. 11 is a diagram showing an example of a hardware configuration of the automated driving control device of the embodiment.

### DESCRIPTION OF EMBODIMENTS

Embodiments of a vehicle control device, a vehicle control method, and a storage medium of the present invention will be described below with reference to the drawings. Hereinafter, an embodiment in which the vehicle control device is applied to an automated driving vehicle will be described as an example. For example, the automated driving is a process of causing a vehicle to travel automatically by controlling one or both of the steering and speed of the vehicle to execute driving control. The above-described driving control may include, for example, various types of driving control such as an adaptive cruise control system (ACC), auto lane changing (ALC), and a lane keeping assistance system (LKAS). Driving of the automated driving vehicle may be controlled according to manual driving of an occupant (a driver).

### [Overall Configuration]

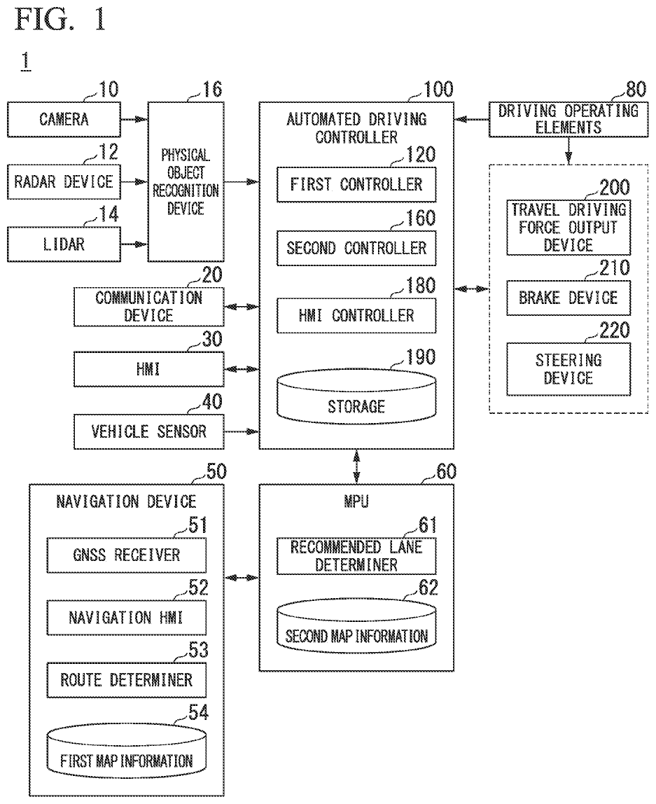

FIG. 1 is a configuration diagram of a vehicle system 1 including a vehicle control device according to an embodiment. For example, a vehicle (hereinafter referred to as a host vehicle M) in which the vehicle system 1 is mounted is a two-wheeled vehicle, a three-wheeled vehicle, or a four-wheeled vehicle. A drive source of the vehicle is an internal combustion engine such as a diesel engine or a gasoline engine, an electric motor, or a combination thereof. The electric motor is operated using electric power generated by an electric power generator connected to the internal combustion engine or electric power with which a battery (a power storage battery) such as a secondary cell or a fuel cell is discharged.

For example, the vehicle system 1 includes a camera 10, a radar device 12, a light detection and ranging (LIDAR) sensor 14, a physical object recognition device 16, a communication device 20, a human machine interface (HMI) 30, a vehicle sensor 40, a navigation device 50, a map positioning unit (MPU) 60, driving operating elements 80, an automated driving controller 100, a travel driving force output device 200, a brake device 210, and a steering device 220. Such devices and equipment are connected to each other by a multiplex communication line such as a controller area network (CAN) communication line, a serial communication line, a wireless communication network, or the like. The configuration shown in FIG. 1 is merely an example and some of the components may be omitted or other components may be further added. The automated driving controller 100 is an example of a “vehicle control device.” An example of an “external environment sensor” is a combination of the camera 10, the radar device 12, the LIDAR 14, and the physical object recognition device 16.

For example, the camera 10 is a digital camera using a solid-state imaging element such as a charge coupled device (CCD) or a complementary metal oxide semiconductor (CMOS). The camera 10 is attached to any position on the host vehicle M in which the vehicle system 1 is mounted. When the view in front of the host vehicle M is imaged, the camera 10 is attached to an upper part of a front windshield, a rear surface of a rearview mirror, a front part of a vehicle body, or the like. When the view to the rear is imaged, the camera 10 is attached to an upper part of a rear windshield, a back door, or the like. When the view to the side is imaged, the camera 10 is attached to a door mirror or the like. For example, the camera 10 periodically and iteratively images the surroundings of the host vehicle M. The camera 10 may be a stereo camera.

The radar device 12 radiates radio waves such as millimeter waves around the host vehicle M and detects at least a position (a distance to and a direction) of a physical object by detecting radio waves (reflected waves) reflected by the physical object near the host vehicle M. The radar device 12 is attached to any location on the host vehicle M. The radar device 12 may detect a position and speed of the physical object in a frequency modulated continuous wave (FM-CW) scheme.

The LIDAR 14 radiates light to the vicinity of the host vehicle M and measures scattered light. The LIDAR 14 detects a distance to an object on the basis of time from light emission to light reception. The radiated light is, for example, pulsed laser light. The LIDAR 14 is attached to any location on the host vehicle M.

The physical object recognition device 16 performs a sensor fusion process on detection results of some or all of the camera 10, the radar device 12, and the LIDAR 14 and recognizes a position, a type, a speed, and the like of a physical object around the host vehicle M. Physical objects include, for example, other vehicles (nearby vehicles such as preceding vehicles), pedestrians, bicycles, road structures, and the like. Road structures include, for example, road signs, traffic lights, railroad crossings, curbs, medians, guardrails, fences, and the like. The road structures may include, for example, road markings such as road lane markings, pedestrian crossings, bicycle crossing zones, and temporary stop lines drawn or affixed to the road surface. The physical objects may include an obstacle such as a falling object on the road (for example, a load of another vehicle or a signboard installed around the road). The physical object recognition device 16 outputs a recognition result to the automated driving controller 100. The physical object recognition device 16 may output the detection results of the camera 10, the radar device 12, and the LIDAR 14 to the automated driving controller 100 as they are. In this case, the physical object recognition device 16 may be omitted from the configuration of the vehicle system 1 or the external environment sensor. The physical object recognition device 16 may be included in the automated driving controller 100.

The communication device 20 uses a network, for example, such as a cellular network, a Wi-Fi network, a Bluetooth (registered trademark) network, a dedicated short range communication (DSRC) network, a local area network (LAN), a wide area network (WAN), or the Internet, to communicate with, for example, other vehicles near the host vehicle M, a communication device of a user using the host vehicle M, or various types of server devices.

The HMI 30 outputs various types of information to an occupant of the host vehicle M and receives an input operation by the occupant. For example, the HMI 30 includes various types of display devices, a speaker, a buzzer, a touch panel, a switch, keys and the like.

The vehicle sensor 40 includes a vehicle speed sensor configured to detect the speed of the host vehicle M, an acceleration sensor configured to detect acceleration, a yaw rate sensor configured to detect a yaw rate (for example, a rotational angular speed around a vertical axis passing through the center of gravity of the host vehicle M), a direction sensor configured to detect a direction of the host vehicle M, and the like. The vehicle sensor 40 may include a position sensor that detects the position of the host vehicle M. The position sensor is, for example, a sensor that acquires position information (longitude/latitude information) from a Global Positioning System (GPS) device. The position sensor may be a sensor that acquires position information using a global navigation satellite system (GNSS) receiver 51 of the navigation device 50. A detection result of the vehicle sensor 40 is output to the automated driving controller 100.

For example, the navigation device 50 includes a global navigation satellite system (GNSS) receiver 51, a navigation HMI 52, and a route determiner 53. The navigation device 50 retains first map information 54 in a storage device such as a hard disk drive (HDD) or a flash memory. The GNSS receiver 51 identifies a position of the host vehicle M on the basis of a signal received from a GNSS satellite. The position of the host vehicle M may be identified or corrected by an inertial navigation system (INS) using an output of the vehicle sensor 40. The navigation HMI 52 includes a display device, a speaker, a touch panel, keys, and the like. The GNSS receiver 51 may be provided in the vehicle sensor 40. The navigation HMI 52 may be partly or wholly shared with the above-described HMI 30. For example, the route determiner 53 determines a route (hereinafter referred to as a route on a map) from the position of the host vehicle M identified by the GNSS receiver 51 (or any input position) to a destination input by the occupant using the navigation HMI 52 with reference to the first map information 54. The first map information 54 is, for example, information in which a road shape is expressed by a link indicating a road of a predetermined section and nodes connected by the link. The first map information 54 may include point of interest (POI) information, and the like. The route on the map is output to the MPU 60. The navigation device 50 may perform route guidance using the navigation HMI 52 on the basis of the route on the map. The navigation device 50 may transmit a current position and a destination to a navigation server via the communication device 20 and acquire a route equivalent to the route on the map from the navigation server. The navigation device 50 outputs the determined route on the map to the MPU 60.

For example, the MPU 60 includes a recommended lane determiner 61 and retains second map information 62 in a storage device such as an HDD or a flash memory. The recommended lane determiner 61 divides the route on the map provided from the navigation device 50 into a plurality of blocks (for example, divides the route every 100 [m] in a traveling direction of the vehicle), and determines a recommended lane for each block with reference to the second map information 62. For example, the recommended lane determiner 61 determines in what lane numbered from the left the vehicle will travel. The recommended lane determiner 61 determines the recommended lane so that the host vehicle M can travel along a reasonable route for traveling to a branching destination when there is a branch point in the route on the map.

The second map information 62 is map information that is more accurate than the first map information 54. The second map information 62 includes, for example, information about a road shape and a road structure and the like. The road shape includes, for example, the number of lanes, a radius of curvature (or curvature) of the road, a width, a slope, and the like as a road shape that is more detailed than that of the first map information 54. The above information may be stored in the first map information 54. Information about the road structure may include information such as a type and a position of the road structure and an orientation, a size, a shape, and a color of a road in an extending direction. In the type of road structure, for example, a road lane marking (hereinafter referred to as a lane marking) may be one type or a lane mark, a curb, a median strip, and the like belonging to the lane marking may be different types. Types of lane markings may include, for example, a lane marking in which the lane change of the host vehicle M is possible and a lane marking in which the lane change is not possible. For example, the type of lane marking may be set for each section of a road or a lane based on a link or a plurality of types may be set within one link.

The second map information 62 may include position information (latitude/longitude) of roads and buildings, address information (address/postal code), facility information, and the like. For example, position information of a lane where a lane change is possible and a lane where the lane change is prohibited (for example, information representing a start position and an end position of each section) may be stored in the second map information 62 on the basis of the above-described type of lane marking. The second map information 62 may be updated at any time by the communication device 20 communicating with the external device. The first map information 54 and the second map information 62 may be provided integrally as map information. The map information (the first map information 54 and the second map information 62) may be stored in the storage 190.

The driving operating elements 80 include, for example, a steering wheel, an accelerator pedal, and a brake pedal. Also, the driving operating elements 80 may include a shift lever, a steering wheel variant, a joystick, and other operating elements. For example, an operation detector that detects an amount of operation of the operating element by the occupant or the presence or absence of an operation is attached to each of the driving operating elements 80. The operation detector detects, for example, a steering angle and a steering torque of the steering wheel, an amount of depression of the accelerator pedal or the brake pedal, and the like. The operation detector outputs detection results to the automated driving controller 100 or some or all of the travel driving force output device 200, the brake device 210, and the steering device 220.

The automated driving controller 100 includes, for example, a first controller 120, a second controller 160, an HMI controller 180, and the storage 190. Each of the first controller 120, the second controller 160, and the HMI controller 180 is implemented, for example, by a hardware processor such as a central processing unit (CPU) executing a program (software). Some or all of these components may be implemented by hardware (a circuit including circuitry) such as a large-scale integration (LSI) circuit, an application specific integrated circuit (ASIC), a field-programmable gate array (FPGA), or a graphics processing unit (GPU) or may be implemented by software and hardware in cooperation. The above-described program may be pre-stored in a storage device (a storage device including a non-transitory storage medium) such as an HDD or a flash memory of the automated driving controller 100 or may be stored in a removable storage medium such as a DVD, a CD-ROM, or a memory card and installed in the storage device of the automated driving controller 100 when the storage medium (the non-transitory storage medium) is mounted in a drive device, a card slot, or the like.

The storage 190 may be implemented by the various types of storage devices described above, an electrically erasable programmable read only memory (EEPROM), a read only memory (ROM), a random access memory (RAM), or the like. The storage 190 stores various types of information, programs, and the like for controlling automated driving in the embodiment. Map information (for example, the first map information 54 and the second map information 62) may be stored in the storage 190.

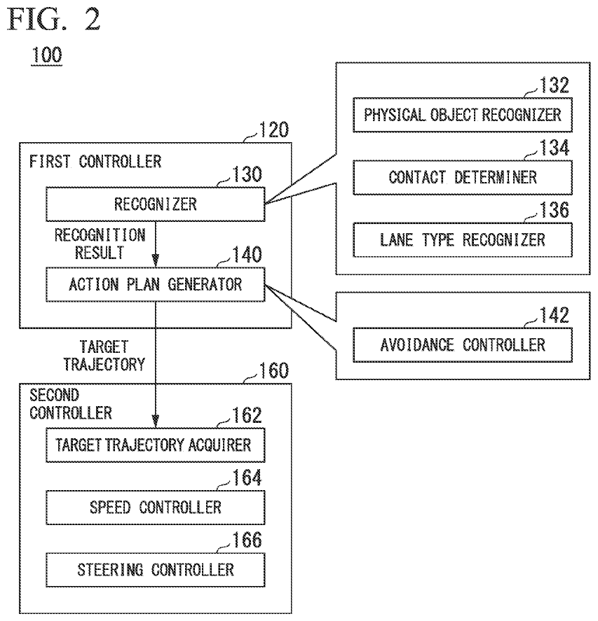

FIG. 2 is a functional configuration diagram of the first controller 120 and the second controller 160. The first controller 120 includes, for example, a recognizer 130 and an action plan generator 140. For example, the first controller 120 implements a function based on artificial intelligence (AI) and a function based on a previously given model in parallel. For example, an “intersection recognition” function may be implemented by executing intersection recognition based on deep learning or the like and recognition based on previously given conditions (signals, road markings, or the like, with which pattern matching is possible) in parallel and performing integrated evaluation by assigning scores to both recognitions. Thereby, the reliability of automated driving is ensured. For example, the first controller 120 executes control related to automated driving of the host vehicle M on the basis of an instruction from the MPU 60, the HMI controller 180, or the like.

The recognizer 130 recognizes states of a position, a velocity, acceleration, and the like of a physical object located near the host vehicle M on the basis of information input from the camera 10, the radar device 12, and the LIDAR 14 via the physical object recognition device 16. For example, the position of the physical object is recognized as a position on absolute coordinates with a representative point (a center of gravity, a driving shaft center, or the like) of the host vehicle M as the origin and is used for control. The position of the physical object may be represented by a representative point (a reference position) such as a center of gravity, a corner, or an end of the physical object or may be represented by a represented region. For example, when the physical object is a mobile object such as another vehicle, the “state” of a physical object may include acceleration or jerk of the mobile object or an “action state” (for example, whether or not a lane change is being made or intended).

The recognizer 130 includes, for example, a physical object recognizer 132, a contact determiner 134, and a lane type recognizer 136. Details of these functions will be described below.

The action plan generator 140 generates an action plan for causing the host vehicle M to travel according to traveling control of automated driving or the like on the basis of a recognition result of the recognizer 130. For example, the action plan generator 140 generates a future target trajectory along which the host vehicle M is allowed to automatically travel (independently of a driver's operation) so that the host vehicle M can generally travel in the recommended lane determined by the recommended lane determiner 61 and further cope with a surrounding situation of the host vehicle M on the basis of a recognition result of the recognizer 130, a surrounding road shape based on a current position of the host vehicle M acquired from the map information, or the like. For example, the target trajectory includes a speed element. For example, the target trajectory is represented by sequentially arranging points (trajectory points) at which the host vehicle M is required to arrive. The trajectory point is a point at which the host vehicle M is required to arrive for each predetermined traveling distance (for example, about several meters [m]). On the other hand, a target speed and target acceleration for each predetermined sampling time period (for example, about several tenths of a second [sec]) are generated as parts of the target trajectory. The trajectory point may be a position at which the host vehicle M is required to arrive at the sampling time for each predetermined sampling time period. In this case, information of the target speed or the target acceleration is represented by an interval between trajectory points.

The action plan generator 140 may set an automated driving event when the target trajectory is generated. For example, the events include a constant-speed traveling event for causing the host vehicle M to travel in the same lane at a constant speed, a tracking traveling event for causing the host vehicle M to track another vehicle (hereinafter referred to as a preceding vehicle) that is within a predetermined distance (for example, within 100 [m]) in front of the host vehicle M and is closest to the host vehicle M, a lane change event for causing the host vehicle M to make a lane change from a host vehicle lane to an adjacent lane, a branching event for causing the host vehicle M to move to a lane in a destination direction at a branch point of a road, a merging event for causing the host vehicle M to move to a lane of a main road at a merging point, a takeover event for ending automated driving and performing switching to manual driving, and the like. For example, the events may include an overtaking event for causing the host vehicle M to make a lane change to a previous lane again after the host vehicle M temporarily makes a lane change to an adjacent lane and overtakes a preceding vehicle, an avoidance event for causing the host vehicle M to perform at least one of braking and steering in order to avoid the contact with a physical object in front of the host vehicle M, and the like.

For example, the action plan generator 140 may change a previously determined event to another event with respect to a current section, or may set a new event with respect to a current section, in accordance with a recognized situation of surroundings of the host vehicle M when the host vehicle M is traveling. Also, the action plan generator 140 may change a previously set event to another event with respect to a current section, or may set a new event with respect to a current section, in accordance with an operation of the occupant on the HMI 30. The action plan generator 140 generates a target trajectory according to the set event.

The action plan generator 140 includes, for example, an avoidance controller 142. Details of the function of the avoidance controller 142 will be described below.

The second controller 160 controls the travel driving force output device 200, the brake device 210, and the steering device 220 so that the host vehicle M passes through the target trajectory generated by the action plan generator 140 at a scheduled time.

The second controller 160 includes, for example, a target trajectory acquirer 162, a speed controller 164, and a steering controller 166. The target trajectory acquirer 162 acquires information of the target trajectory (trajectory points) generated by the action plan generator 140 and causes a memory (not shown) to store the information. The speed controller 164 controls the travel driving force output device 200 or the brake device 210 on the basis of the speed element associated with the target trajectory stored in the memory. The steering controller 166 controls the steering device 220 in accordance with a degree of curvature of the target trajectory stored in the memory. For example, processes of the speed controller 164 and the steering controller 166 are implemented by a combination of feed-forward control and feedback control. As one example, the steering controller 166 executes feed-forward control according to a curvature radius (or curvature) of the road in front of the host vehicle M and feedback control based on a deviation of the host vehicle M from the target trajectory in combination.

Returning to FIG. 1, the HMI controller 180 notifies the occupant of predetermined information by means of the HMI 30. For example, the predetermined information includes information related to traveling of the host vehicle M such as information about the state of the host vehicle M and information about driving control. The information about the state of the host vehicle M includes, for example, a speed of the host vehicle M, an engine speed, a shift position, and the like. The information about the driving control includes, for example, the presence or absence of execution of the driving control based on automated driving, information for asking about whether or not to start the automated driving, information for prompting an occupant to perform manual driving, information about a situation of the driving control by the automated driving (for example, content of an event which is being executed), and the like. The predetermined information may include information that is not related to the traveling control of the host vehicle M, such as content (for example, a movie) stored in a storage medium such as a television program or a DVD. The predetermined information may include, for example, information about a current position and a destination of the host vehicle M and the remaining amount of fuel. The HMI controller 180 may output the information received by the HMI 30 to the communication device 20, the navigation device 50, the first controller 120, and the like. The HMI controller 180 may transmit various types of information to be output to the HMI 30 to a terminal device used by the user (the occupant) of the host vehicle M via the communication device 20. The terminal device is, for example, a smartphone or a tablet terminal.

The travel driving force output device 200 outputs a travel driving force (torque) for enabling the host vehicle M to travel to driving wheels. For example, the travel driving force output device 200 includes a combination of an internal combustion engine, an electric motor, a transmission, and the like, and an electronic control unit (ECU) that controls the internal combustion engine, the electric motor, the transmission, and the like. The ECU controls the above-described components in accordance with information input from the second controller 160 or information input from the accelerator pedal that is the driving operating element 80.

For example, the brake device 210 includes a brake caliper, a cylinder configured to transfer hydraulic pressure to the brake caliper, an electric motor configured to generate hydraulic pressure in the cylinder, and a brake ECU. The brake ECU controls the electric motor in accordance with the information input from the second controller 160 or the information input from the brake pedal that is the driving operating element 80 so that brake torque according to a braking operation is output to each wheel. The brake device 210 may include a mechanism configured to transfer the hydraulic pressure generated by an operation of the brake pedal to the cylinder via a master cylinder as a backup. The brake device 210 is not limited to the above-described configuration and may be an electronically controlled hydraulic brake device configured to control the actuator in accordance with information input from the second controller 160 and transfer the hydraulic pressure of the master cylinder to the cylinder.

For example, the steering device 220 includes a steering ECU and an electric motor. For example, the electric motor changes a direction of steerable wheels by applying a force to a rack and pinion mechanism. The steering ECU drives the electric motor in accordance with the information input from the second controller 160 or the information input from the steering wheel that is the driving operating element 80 to cause the direction of the steerable wheels to be changed.

### [Functions of Recognizer and Action Plan Generator]

Hereinafter, functions of the recognizer 130 and the action plan generator 140 according to the embodiment will be described in detail. Hereinafter, the functions of the recognizer 130 and the action plan generator 140 associated with avoidance control for the host vehicle M to avoid contact with a physical object will be mainly described. A preceding vehicle traveling in front of the host vehicle M is used as an example of the physical object. A target physical object may be a physical object such as another nearby vehicle (for example, a following vehicle) or an obstacle (for example, a falling object) instead of (or in addition to) the preceding vehicle.

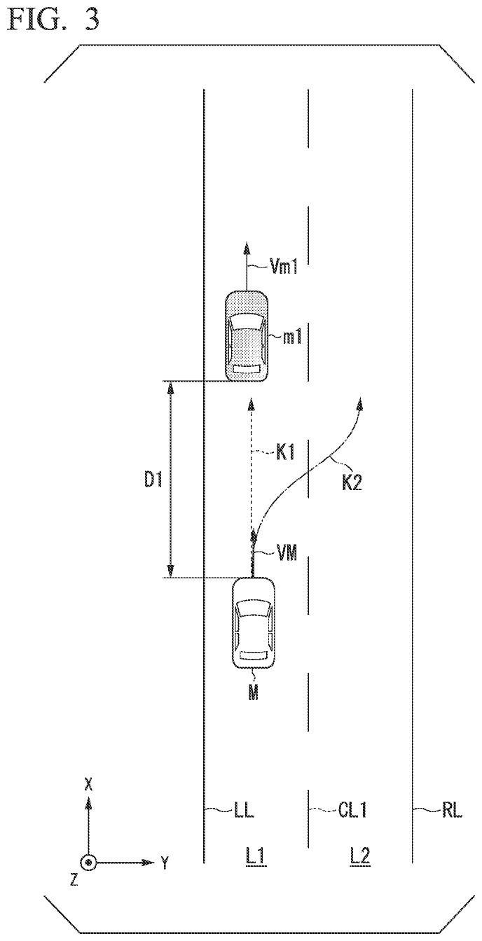

FIG. 3 is a diagram for describing the recognizer 130 and the action plan generator 140. In the example of FIG. 3, two lanes L1 and L2 in which travel can be performed in the same direction (an X-axis direction in FIG. 3) are shown. The lane L1 is partitioned by lane markings LL and CL1 and the lane L2 is partitioned by lane markings CL1 and RL. In the example of FIG. 3, it is assumed that the host vehicle M and a preceding vehicle m1 present in front of the host vehicle M are traveling at speeds VM and Vm1 in the lane L1, respectively. Hereinafter, the lane L1 in which the host vehicle M is traveling is referred to as a “host vehicle lane L1” and the lane L2 adjacent to the host vehicle lane L1 is referred to as an “adjacent lane L2.”

The physical object recognizer 132 recognizes information about a position, a size, a speed, and a traveling direction of a physical object near the host vehicle M, for example, on the basis of a recognition result of the external environment sensor. The position and the speed of the physical object may be a relative position and a relative speed of another vehicle with respect to the host vehicle M. The physical object near the host vehicle M is, for example, a physical object within a predetermined distance from the host vehicle M. The physical object near the host vehicle M may be a physical object present in the host vehicle lane L1 and the adjacent lane L2. In the example of FIG. 3, when the preceding vehicle m1 is present within a predetermined distance from the host vehicle M, the physical object recognizer 132 recognizes, for example, a position of the preceding vehicle m1, a relative distance D1, a relative speed ΔV (VM−Vm1), and the like with respect to the host vehicle M.

The contact determiner 134 determines whether or not the host vehicle M is likely to come in contact with another vehicle recognized by the physical object recognizer 132. For example, the contact determiner 134 calculates a margin time period TTC1 until the host vehicle M comes in contact with the preceding vehicle m1 on the basis of the relative distance D1 and the relative speed ΔV of the preceding vehicle m1 with respect to the host vehicle M. The margin time period TTC1 is calculated by, for example, dividing the relative distance D1 by the relative speed ΔV. The contact determiner 134 determines that the host vehicle M is likely to come in contact with the preceding vehicle m1 when the calculated margin time period TTC1 is within a first predetermined time period Tth1 and determines that the host vehicle M is unlikely to come in contact with the preceding vehicle m1 when the calculated margin time period TTC1 is greater than the first predetermined time period Tth1.

The contact determiner 134 may determine whether or not the host vehicle M will come in contact with the preceding vehicle m1 on the basis of an amount of change in the relative distance D1 or the relative speed ΔV instead of (or in addition to) the above-described margin time period TTC. For example, when the amount of change in the relative distance D1 or the relative speed ΔV exceeds a threshold value due to sudden braking or interruption of the preceding vehicle m1 or the like, the contact determiner 134 determines that the host vehicle M is likely to come in contact with the preceding vehicle m1. When the amount of change is less than or equal to the threshold value, the contact determiner 134 determines that the host vehicle M is unlikely to come in contact with the preceding vehicle m1.

The lane type recognizer 136 recognizes a lane type of the host vehicle lane L1 in which the host vehicle M is traveling. The lane type includes, for example, a type for identifying whether the host vehicle lane L1 in which the host vehicle M is traveling is a lane where a lane change is possible or a lane where a lane change is prohibited. The above-described lane type may be acquired for each section. The “section” here may be, for example, a road section separated by identification information for identifying a road link or may be a road section within a predetermined distance from a current position of the host vehicle M.

For example, the lane type recognizer 136 analyzes an image captured by the camera 10 and recognizes a line type of the lane marking (for example, the lane marking CL1 shown in FIG. 3) that partitions the host vehicle lane L1 and the adjacent lane L2 on the road. The line type may include not only a type based on a shape such as a solid line or a broken line, but also a type based on a color. The lane type recognizer 136 recognizes a lane type (a road type) of the host vehicle lane L1 on the basis of the recognized line type.

The lane type recognizer 136 may recognize a type of lane where the host vehicle M is traveling from the map information with reference to the map information (for example, the first map information 54 and the second map information 62) on the basis of position information of the host vehicle M instead of (or in addition to) recognizing the lane type using an image captured by the camera 10. When each lane type has been recognized from the image captured by the camera 10 and the map information, the lane type recognizer 136 may perform a matching process on recognition results. In this case, the lane type recognizer 136 recognizes a lane type as an actual lane type when the lane types that have been obtained are the same and recognizes a lane type in which the host vehicle M is subjected to safer driving control as an actual lane type when they are not the same. The safer driving control is, for example, driving control in which a change in the behavior of the host vehicle M is less. For example, when a lane type recognized from the image captured by the camera 10 is a lane where a lane change is possible and a lane type recognized from the map information is a lane where a lane change is prohibited, the lane type recognizer 136 recognizes a lane type as a lane where the lane change is prohibited for the safer driving control. Thereby, more appropriate driving control (for example, avoidance control to be described below) can be executed.

The lane type recognizer 136 may recognize a lane type of a lane where the host vehicle M will travel in the near future on the basis of the image captured by the camera 10 or the map information. The “lane where the host vehicle M will travel in the near future” is, for example, a lane in which the host vehicle M is predicted to arrive within a predetermined time on the basis of the speed and the traveling direction of the host vehicle M or a lane within a predetermined distance in the traveling direction of the host vehicle M. The lane type recognizer 136 may recognize, for example, a position where the lane type is switched, a distance from the current position of the host vehicle M to a position where the lane type is switched, and a section having the same lane type.

The avoidance controller 142 executes driving control for avoiding contact between the host vehicle M and the preceding vehicle m1 when the contact determiner 134 determines that the host vehicle M is likely to come in contact with the preceding vehicle m1. For example, the avoidance controller 142 can execute first avoidance control for avoiding contact with the preceding vehicle m1 through control of the braking of the host vehicle M (for example, brake control) and second avoidance control for avoiding contact with the preceding vehicle m1 through movement of the host vehicle M in a vehicle width direction.

For example, when the first avoidance control is executed, the avoidance controller 142 generates a target trajectory K1 for decelerating the host vehicle M to a speed at which the host vehicle M will not come in contact with the preceding vehicle m1 on the basis of the relative distance D1 or the relative speed ΔV between the host vehicle M and the preceding vehicle m1. When the second avoidance control is executed, the avoidance controller 142 generates a target trajectory K2 along which the host vehicle M is moved in a direction including the vehicle width direction (a horizontal direction or a Y-axis direction in FIG. 3) from the host vehicle lane L1 according to steering control on the basis of the relative distance D1 or the relative speed ΔV between the host vehicle M and the preceding vehicle m1. The second avoidance control may include braking control for the second avoidance control so that the host vehicle M can move in the vehicle width direction more smoothly and more safely. The target trajectory K2 may be a trajectory for allowing a part of the host vehicle M to enter the adjacent lane L2 so that contact between the host vehicle M and the preceding vehicle m1 is avoided or a trajectory along which the lane change from the host vehicle lane L1 to the adjacent lane L2 is made. The avoidance controller 142 generates the target trajectory K2 for moving the host vehicle M so that the host vehicle M does not come in contact with the preceding vehicle m1 or another physical object on the basis of a recognition result of the external environment sensor. Hereinafter, the second avoidance control will be described as control for causing the lane change of the host vehicle M from the host vehicle lane L1 to the adjacent lane L2 to be made according to the movement of the host vehicle M in the vehicle width direction. The avoidance controller 142 outputs the generated target trajectory to the second controller 160 and therefore automated driving is executed so that the host vehicle M is unlikely to come in contact with the preceding vehicle m1.

For example, the avoidance controller 142 selects either the first avoidance control or the second avoidance control on the basis of the lane type of the host vehicle lane L1 recognized by the lane type recognizer 136 and preferentially executes the selected avoidance control. For example, the avoidance controller 142 preferentially executes the second avoidance control when the host vehicle lane L1 where the host vehicle M is traveling is a lane where a lane change is possible and preferentially executes the first avoidance control when the host vehicle lane L1 where the host vehicle M is traveling is a lane where a lane change is prohibited. “Preferentially executing” means, for example, executing the preferential avoidance control before other avoidance control. Therefore, for example, “preferentially executing” may also include executing the other type of avoidance control (for example, the second avoidance control) while the one type of avoidance control is being executed or after the one type of avoidance control is executed in a case in which contact with the preceding vehicle m1 is likely to occur even if the preferential type of avoidance control (for example, the first avoidance control) is executed.

In the example of FIG. 3, the lane marking CL1 is a road lane marking indicating a lane where a lane change is possible. In this case, when the contact determiner 134 determines that the host vehicle M is likely to come in contact with the preceding vehicle m1, the avoidance controller 142 generates the target trajectory K2 for avoiding the contact with the preceding vehicle m1 through the lane change from the host vehicle lane L1 to the adjacent lane L2 as the second avoidance control.

Even if the lane where the host vehicle M is traveling is a lane where a lane change is possible, the avoidance controller 142 may preferentially execute the first avoidance control when there is another vehicle in the adjacent lane L2 to which the host vehicle M would change lanes according to the second avoidance control. The above-mentioned other vehicle is the preceding vehicle or the following vehicle that is traveling in the adjacent lane L2. Therefore, the above-described preceding vehicle includes a vehicle in a forward direction or a side forward direction when viewed from the host vehicle M among other vehicles near the host vehicle M recognized by the physical object recognizer 132 and the above-described following vehicle includes a vehicle in a rearward direction or a side rearward direction when viewed from the host vehicle M among the other vehicles. Hereinafter, a situation in which there is a following vehicle in the adjacent lane L2 will be mainly described.

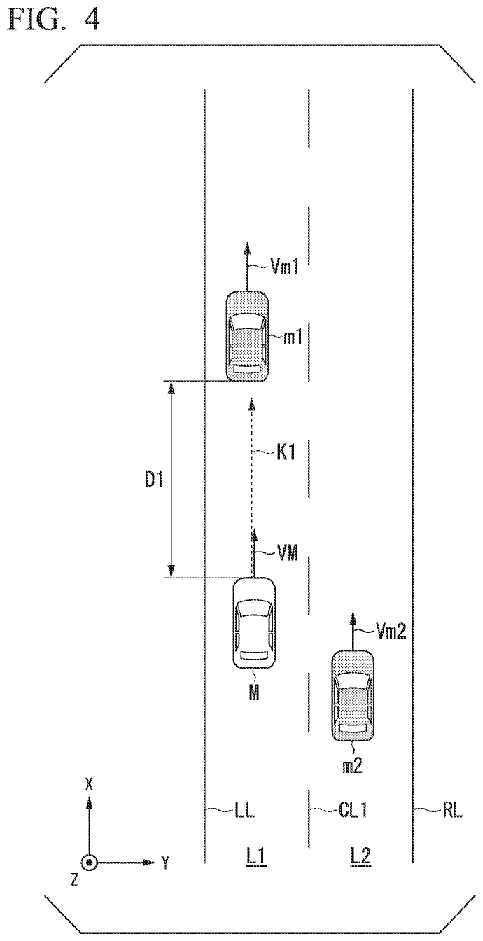

FIG. 4 is a diagram for describing avoidance control in a situation in which there is a following vehicle in the adjacent lane L2. FIG. 4 is different from FIG. 3 in that there is a following vehicle m2 which is traveling in the adjacent lane L2 at a speed Vm2 in a side rearward direction of the host vehicle M. Even if the contact determiner 134 determines that the host vehicle M is likely to come in contact with the preceding vehicle m1 and the lane type recognizer 136 recognizes that the lane where the host vehicle M is traveling is a lane where a lane change is possible, the avoidance controller 142 preferentially executes the first avoidance control when the following vehicle m2 is present near the host vehicle M in the adjacent lane L2 as shown in FIG. 4. The avoidance controller 142 executes the second avoidance control when the adjacent lane L2 becomes a lane where a lane change is possible after the first avoidance control is preferentially executed. A case in which a lane change is possible is, for example, a case in which a distance between the host vehicle M and the following vehicle m2 after the first avoidance control is preferentially executed is greater than or equal to a predetermined distance. For example, the predetermined distance is an estimated distance at which there is no contact with the following vehicle m2 even if the host vehicle M changes lanes to the adjacent lane L2 on the basis of a relative position, a relative speed, or the like between the host vehicle M and the following vehicle m2. For example, cases in which the distance is greater than or equal to the predetermined distance include a case in which the distance from the host vehicle M increases after the following vehicle m2 passes by the side of the host vehicle M or a case in which the distance from the host vehicle M increases due to the deceleration of the following vehicle m2. Thereby, it is possible to limit contact between the host vehicle M and the following vehicle m2 by making a lane change to the adjacent lane L2 so that contact with the preceding vehicle m1 is avoided. Because the first avoidance control or the second avoidance control can be switched and executed through a simple determination of whether or not the following vehicle m2 is present in the adjacent lane L2, it is possible to execute more appropriate avoidance control in accordance with a state of surroundings of the host vehicle M while reducing the processing load. The avoidance controller 142 may include whether or not the following vehicle m2 is present at a position where the following vehicle m2 is estimated to be in contact with the host vehicle M due to a lane change of the host vehicle M in a condition for selecting the avoidance control thereafter on the basis of a relative position, a relative speed, or the like associated with the host vehicle M in addition to whether or not the following vehicle m2 is present in the adjacent lane L2. The avoidance controller 142 may perform similar control even if there is a preceding vehicle in the adjacent lane L2 instead of the following vehicle m2.

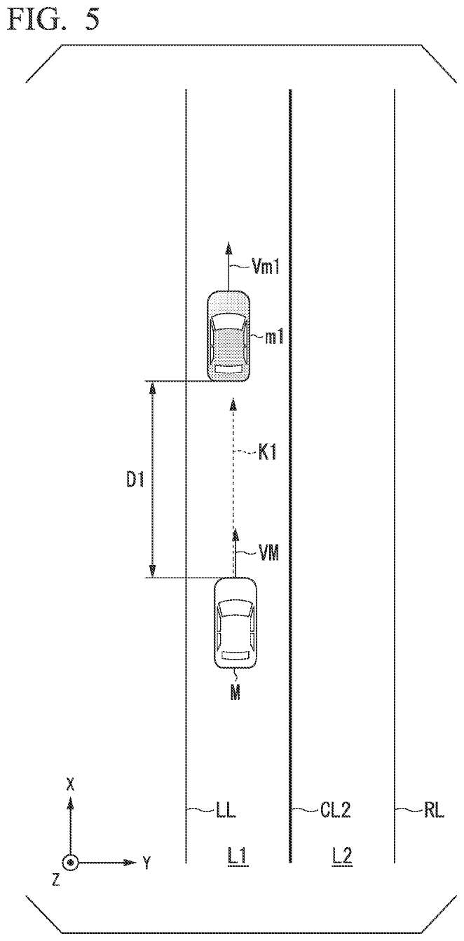

FIG. 5 is a diagram for describing avoidance control in a situation in which the host vehicle M is traveling in a lane where a lane change is prohibited. FIG. 5 is different from FIG. 3 in that the lane marking CL2 indicating the lane where a lane change is prohibited is shown instead of the lane marking CL1. For example, when the host vehicle M is traveling in the lane where a lane change is prohibited as shown in FIG. 5 at a point in time when the contact determiner 134 determines that the host vehicle M is likely to come in contact with the preceding vehicle m1, the avoidance controller 142 causes the host vehicle M to decelerate to a speed at which contact with the preceding vehicle m1 is not caused as the first avoidance control and generates the target trajectory K1 for avoiding contact between the host vehicle M and the preceding vehicle m1. The “speed at which contact is not caused” is, for example, a speed of the host vehicle M relative to the preceding vehicle m1 less than or equal to a predetermined speed. The predetermined speed is variably set on the basis of, for example, the relative distance D1. The predetermined speed may be set variably on the basis of an estimated predetermined distance at which the host vehicle M can safely stop in a state in which the host vehicle M is not in contact with the preceding vehicle m1 instead of the relative distance D1. Thereby, it is possible to reliably avoid contact with the preceding vehicle m1 and cause the host vehicle M to travel in compliance with the road regulations of the traveling lane. When the avoidance control is executed, safer traffic can also be implemented by limiting the behavior of the host vehicle M that is not expected for the nearby vehicles as much as possible. Although a relationship between the host vehicle M and the preceding vehicle m1 in the lane where a lane change is prohibited has been described in the example of FIG. 5, a target trajectory for avoiding contact between the host vehicle M and the following vehicle may be also generated as the first avoidance control with respect to the following vehicle associated with the host vehicle M (the following vehicle that is traveling in the same lane L1 as the host vehicle M) instead of (or in addition to) the preceding vehicle m1. An inter-vehicle distance between the host vehicle M and another vehicle or the speed of the host vehicle M are variably set according to the first avoidance control.

The avoidance controller 142 may execute the second avoidance control after executing the first avoidance control when the traveling lane of the host vehicle M at a point in time when the contact determiner 134 determines that the host vehicle M is likely to come in contact with the preceding vehicle m1 is a lane where a lane change is prohibited and the lane change prohibition will be lifted in the near future (in other words, the traveling lane will change to a lane where a lane change is possible in the near future).

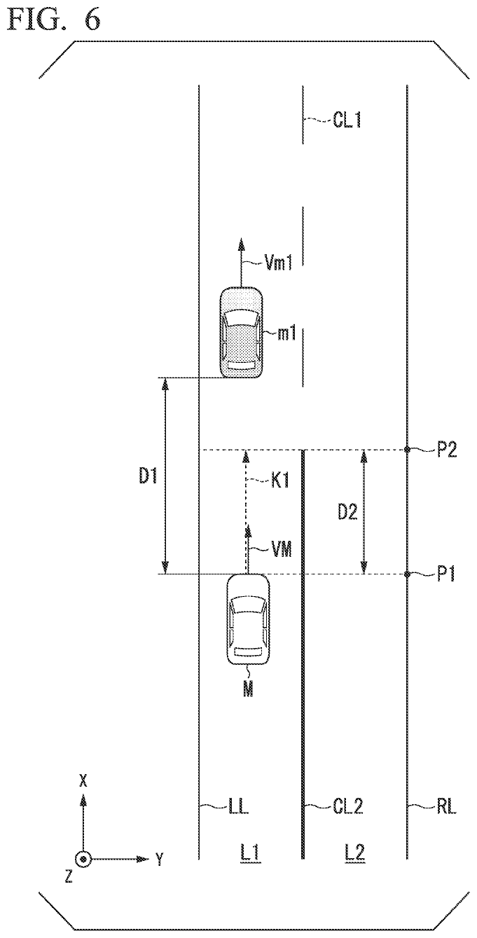

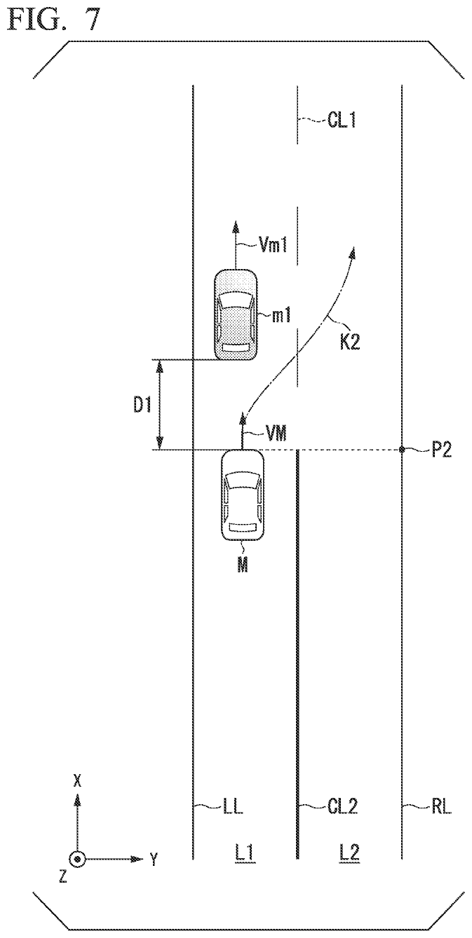

FIGS. 6 and 7 are diagrams (parts 1 and 2) for describing avoidance control in a situation in which the host vehicle lane changes from a lane where a lane change is prohibited to a lane where a lane change is possible. In the examples of FIGS. 6 and 7, a situation in which a type of lane marking for partitioning the host vehicle lane L1 and the adjacent lane L2 changes from a lane where a lane change is prohibited (a section indicated by the lane marking CL2 in FIGS. 6 and 7) to a lane where a lane change is possible (a section indicated by the lane marking CL1 in FIGS. 6 and 7) is shown.

For example, when it is determined that the host vehicle M is likely to come in contact with the preceding vehicle m1 at a point in time when a reference point (for example, a front end) of the host vehicle M has reached a point P1 shown in FIG. 6, the avoidance controller 142 calculates a distance D2 from the point P1 to a point P2 where the lane type changes and determines whether or not the calculated distance D2 is within a first predetermined distance Dth1. The avoidance controller 142 determines that the lane change prohibition will be lifted in the near future when the distance D2 is within the first predetermined distance Dth1 and determines that the lane change prohibition will not be lifted in the near future when the distance D2 is longer than the first predetermined distance Dth1. The first predetermined distance Dth1 is variably set according to, for example, the speed of the host vehicle M, the relative distance D1 or the relative speed ΔV between the host vehicle M and the preceding vehicle m1, the weather, road surface conditions, or the like. Thereby, more appropriate avoidance control can be performed in accordance with the behavior of the host vehicle M and the situation of surroundings of the host vehicle M. The first predetermined distance Dth1 may be a fixed distance.

When it is determined that the lane change prohibition will not be lifted in the near future, the avoidance controller 142 executes only the first avoidance control for controlling the braking of the host vehicle M to avoid contact with the preceding vehicle m1. When it is determined that the lane change prohibition will be lifted in the near future, the avoidance controller 142 executes the second avoidance control after executing the first avoidance control. In this case, for example, as shown in FIG. 6, the avoidance controller 142 generates the target trajectory K1 so that the first avoidance control is completed by the time the host vehicle M travels the distance D2 (in other words, by the time the host vehicle M reaches the point P2) and executes driving control so that the host vehicle M travels along the generated target trajectory K1. The avoidance controller 142 may generate the target trajectory K1 so that the first avoidance control is completed by the time the host vehicle M travels a distance corresponding to the relative distance D1 at a current point in time instead of the distance D2.

FIG. 7 shows a situation in which the first avoidance control is executed and the host vehicle M reaches a position of a point P2. In this situation, the avoidance controller 142 executes automated control for generating the target trajectory K2 for making the lane change to the adjacent lane L2 in the lane where a lane change is possible and causing the host vehicle M to travel along the generated target trajectory K2 as the second avoidance control. The avoidance controller 142 may generate a target trajectory (for example, a trajectory corresponding to a target trajectory K1+K2) along which the first avoidance control and the second avoidance control are continuously executed. Thereby, it is possible to execute safer avoidance control in compliance with the road regulations of the traveling lane.

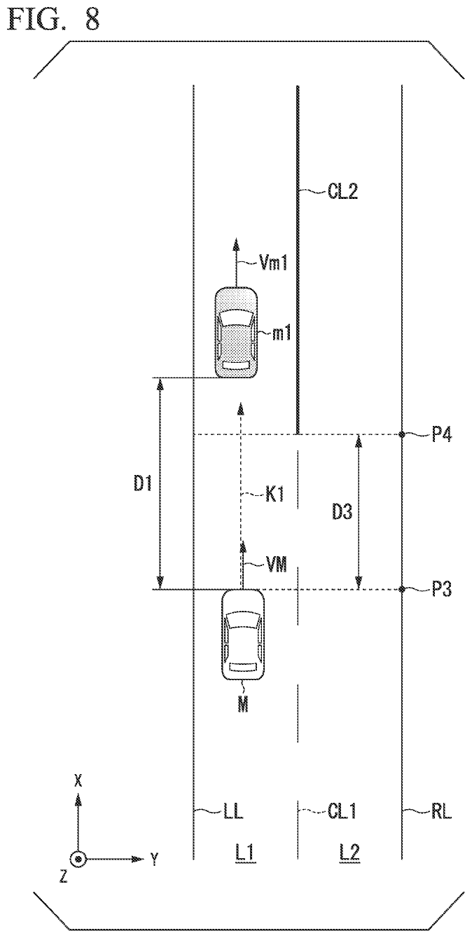

The avoidance controller 142 may preferentially execute the first avoidance control when the host vehicle lane L1 is a lane where a lane change is possible and will change to a lane where a lane change is prohibited in the near future on the basis of a lane type of a road when it is determined that contact with the preceding vehicle m1 is likely to occur. FIG. 8 is a diagram for describing avoidance control in a situation in which a change from a lane where a lane change is possible to a lane where a lane change is prohibited is made. For example, when it is determined that contact with the preceding vehicle m1 is likely to occur at a point in time when the reference point of the host vehicle M has reached the point P3 shown in FIG. 8, the avoidance controller 142 calculates a distance D3 from the point P3 to a point P4 where the lane type changes and determines whether or not the calculated distance D3 is within a second predetermined distance Dth2. The avoidance controller 142 determines that the lane will change to the lane where a lane change is prohibited in the near future when the distance D3 is within the second predetermined distance Dth2 and determines that the lane will not change to the lane where a lane change is prohibited in the near future when the distance D3 is longer than the second predetermined distance Dth2. The second predetermined distance Dth2 is variably set according to, for example, the speed of the host vehicle M, the relative distance D1 or the relative speed ΔV between the host vehicle M and the preceding vehicle m1, the weather, road surface conditions, or the like. Thereby, more appropriate avoidance control can be performed in accordance with the behavior of the host vehicle M and the situation of surroundings of the host vehicle M. The second predetermined distance Dth2 may be a fixed distance.

When it is determined that the lane where the vehicle is traveling will not change to a lane where a lane change is prohibited in the near future, the avoidance controller 142 controls the steering of the host vehicle M to execute the second avoidance control for avoiding contact with the preceding vehicle m1 according to the lane change to the adjacent lane L2. When it is determined that the lane where the host vehicle M is traveling will change to a lane where a lane change is prohibited in the near future, the avoidance controller 142 controls the braking of the host vehicle M to execute the first avoidance control for avoiding contact with the preceding vehicle m1 as shown in FIG. 8. Thereby, it is possible to limit a significant change in the behavior of the host vehicle M due to a sudden lane change before the lane type changes to a lane where a lane change is prohibited. It is possible to limit an influence on nearby vehicles due to a sudden change in the behavior of the host vehicle M. The above-described process of the avoidance controller 142 may be executed as an avoidance event.

### [Processing Flow]

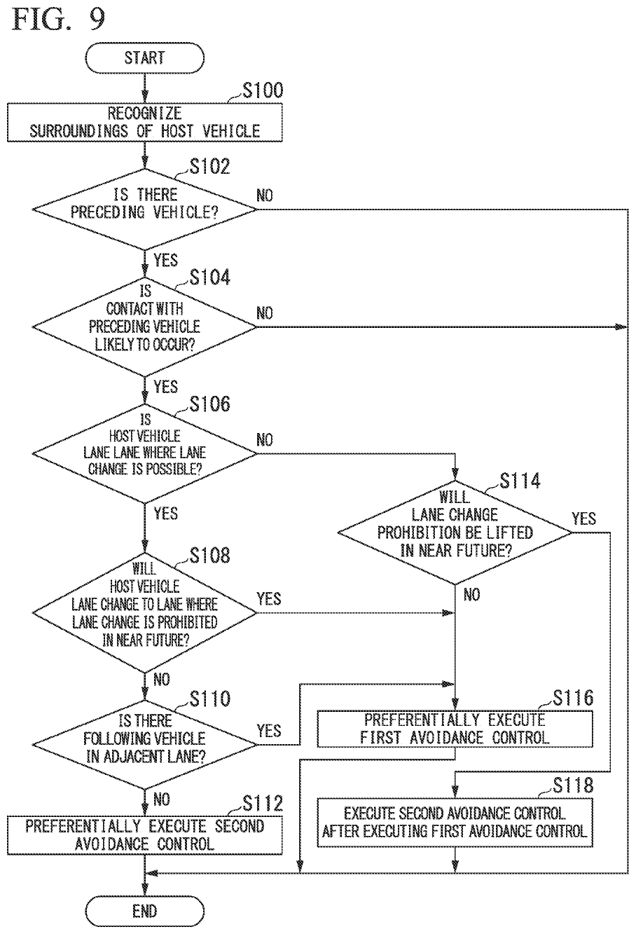

FIG. 9 is a flowchart showing an example of a flow of a process executed by the automated driving controller 100 of the embodiment. Hereinafter, a process associated with avoidance of contact between the host vehicle M and the preceding vehicle m1 within the process executed by the automated driving controller 100 will be mainly described. The process shown in FIG. 9 may be iteratively executed at a predetermined timing or a predetermined interval, for example, during the execution of the automated driving.

In the example of FIG. 9, first, the recognizer 130 recognizes surroundings of the host vehicle M (step S100). Subsequently, the physical object recognizer 132 determines whether or not a preceding vehicle m1 is present in front of the host vehicle M (step S102). When it is determined that a preceding vehicle is present, the contact determiner 134 determines whether or not the host vehicle M is likely to come in contact with the preceding vehicle m1 (step S104). When it is determined that the host vehicle M is likely to come in contact with the preceding vehicle m1, the avoidance controller 142 determines whether or not the host vehicle lane L1 where the host vehicle M is traveling is a lane where a lane change of the host vehicle M is possible (step S106).

When it is determined that the host vehicle lane L1 is a lane where a lane change is possible, the avoidance controller 142 determines whether or not the host vehicle lane L1 will change to a lane where a lane change is prohibited in the near future (step S108). When it is determined that the host vehicle lane L1 will not change to the lane where a lane change is prohibited in the near future, the avoidance controller 142 determines whether or not a following vehicle m2 near the host vehicle M is present in the adjacent lane L2 (step S110). When it is determined that a following vehicle m2 near the host vehicle M is not present in the adjacent lane L2, the avoidance controller 142 preferentially executes the second avoidance control (step S112).

When it is determined that the host vehicle lane L1 where the host vehicle M is traveling is not a lane where a lane change is possible (in other words, the host vehicle lane L1 where the host vehicle M is traveling is a lane where a lane change is prohibited) in the processing of step S106, the avoidance controller 142 determines whether or not the lane change prohibition will be lifted in the near future (step S114). When it is determined that the lane change prohibition will not be lifted in the near future, the avoidance controller 142 preferentially executes the first avoidance control (step S116). When it is determined that the host vehicle lane L1 will change to a lane where a lane change is prohibited in the near future in the processing of step S108 or when it is determined that a following vehicle m2 is present in the adjacent lane in the processing of step S110, the processing of step S116 is executed.

When it is determined that the lane change prohibition will be lifted in the near future in the processing of step S114, the avoidance controller 142 executes the second avoidance control after executing the first avoidance control (step S118). Thereby, the process of the present flowchart ends. When it is determined that a preceding vehicle is not present in the processing of step S102 or when it is determined that contact with a preceding vehicle is unlikely to occur in the processing of step S104, the process of the present flowchart ends.

### [Modified Examples]

In the above-described embodiment, when the avoidance controller 142 causes the host vehicle M to be moved in the vehicle width direction according to the second avoidance control, the avoidance controller 142 may cause the host vehicle M to be moved in a range that does not exceed the host vehicle lane L1 instead of causing the vehicle M to enter the adjacent lane L2. In this case, when there is a space to which the host vehicle M can move and where the host vehicle M does not exceed the host vehicle lane L1 on the right side or the left side of the preceding vehicle m1, the avoidance controller 142 generates the target trajectory K2 along which the host vehicle M moves to the above-described space. It may be determined whether or not to perform movement until the host vehicle M enters the adjacent lane L2 on the basis of, for example, the lane type of the host vehicle lane L1 or according to the presence or absence of a following vehicle. Thereby, more appropriate avoidance control can be performed according to a situation of surroundings of the host vehicle M.

In the above-described embodiment, in the second avoidance control, the avoidance controller 142 may execute the lane change for returning to the original lane L1 after the host vehicle M makes a lane change to the adjacent lane L2 and passes the preceding vehicle m1. Thereby, the host vehicle M can travel while maintaining a recommended lane for heading to a destination as much as possible.

In the embodiment, when either the first avoidance control or the second avoidance control is preferentially executed to avoid contact with the preceding vehicle m1, the avoidance controller 142 may adjust a priority level in accordance with a situation of surroundings of the host vehicle M. For example, the avoidance controller 142 necessarily executes the first avoidance control when the lane where the host vehicle M is traveling is a lane where a lane change is prohibited in the situation in which the avoidance control for avoiding the contact with the preceding vehicle m1 is executed and preferentially execute the first avoidance control when the lane where the host vehicle M is traveling is a lane where a lane change is possible and will change to a lane where a lane change is prohibited in the near future. However, the avoidance controller 142 executes the second avoidance control even before the first avoidance control is executed or even if the first avoidance control is being executed when it is predicted that contact with the preceding vehicle m1 is likely to occur even if the first avoidance control is executed. In this way, more appropriate avoidance control can be implemented by adjusting the priority degree in accordance with a surrounding situation.

Although a case in which the automated driving controller 100 controls the host vehicle M has been described in the above-described embodiment, a process associated with the above-described avoidance control may be applied to a driving assistance device for assisting the occupant of the host vehicle M in performing driving instead of (or in addition to) the control. Hereinafter, differences from the embodiment using the automated driving controller 100 will be mainly described with respect to an example in which the above-described avoidance control is applied to the driving assistance device.

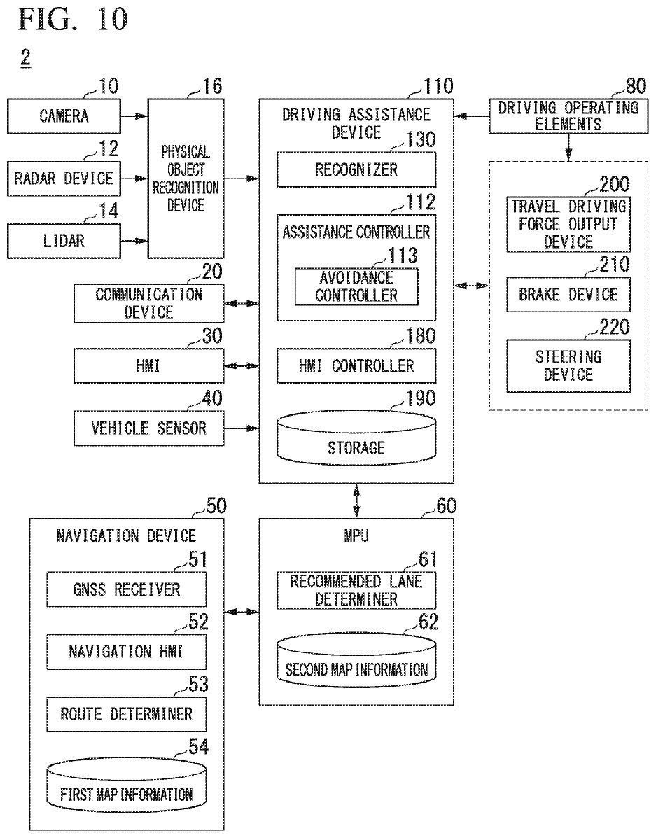

FIG. 10 is a diagram showing an example of a functional configuration of a vehicle system 2 including a driving assistance device 110. Compared with the vehicle system 1, the vehicle system 2 shown in FIG. 10 includes a driving assistance device 110 instead of the automated driving controller 100. The driving assistance device 110 is an example of a “vehicle controller.” The driving assistance device 110 includes, for example, a recognizer 130, an assistance controller 112, an HMI controller 180, and a storage 190. The recognizer 130 has a functional configuration similar to that of the recognizer 130 of the automated driving controller 100.

The assistance controller 112 assists the occupant of the host vehicle M in performing driving. The assistance is, for example, a function in which at least one of the speed and steering of the host vehicle M is controlled by the driving assistance device 110. The assistance controller 112 executes, for example, ACC, ALC, or LKAS as driving assistance for the occupant. The assistance controller 112 includes, for example, an avoidance controller 113. The avoidance controller 113 has a function similar to that of the avoidance controller 142 described above and also performs control associated with driving assistance. Specifically, the avoidance controller 113 selects and executes either the first avoidance control or the second avoidance control on the basis of the lane type of the host vehicle lane L1 recognized by the recognizer 130 or the like when the contact between the host vehicle M and the preceding vehicle m1 is avoided. Because a process having a flow similar to that of the above-described process executed by the driving assistance device 110 (more specifically, a process in which the avoidance controller 142 is replaced with the avoidance controller 113) can be applied as the process executed by the automated driving controller 100, specific description thereof will be omitted here.

According to the above-described embodiment, the vehicle controller (the automated driving controller 100 or the driving assistance device 110) includes the recognizer 130 configured to recognize surroundings of the host vehicle M; and the avoidance controller 142 configured to be able to execute first avoidance control for avoiding contact with a physical object recognized by the recognizer 130 according to braking of the host vehicle M and second avoidance control for avoiding the contact with the physical object recognized by the recognizer 130 according to movement of the host vehicle M in a vehicle width direction, wherein, when the contact between the host vehicle M and the physical object is avoided, the avoidance controller 142 executes either the first avoidance control or the second avoidance control on the basis of a lane type of a host vehicle lane recognized by the recognizer 130, so that more appropriate avoidance control can be executed.

Specifically, in the embodiment, for example, if a physical object to be avoided is present in front of the host vehicle M while the host vehicle M is traveling, the second avoidance control (for example, steering control) is preferentially executed when the traveling lane of the host vehicle M is a lane where a lane change is possible and the first avoidance control (for example, brake control) is preferentially executed when the traveling lane is a lane where a lane change is prohibited. Therefore, for example, even if the host vehicle M can avoid contact with the preceding vehicle m1 according to the second avoidance control, the first avoidance control is performed when the host vehicle lane is a lane change prohibition section, so that it is possible to reliably avoid contact with the preceding vehicle m1 and to avoid contact in compliance with the road regulations of the lane. It is possible to prevent the occupants of the nearby vehicles from feeling uncomfortable due to avoidance control performed without observing the road regulations and limit the necessity for the nearby vehicle to execute control for avoiding contact with the host vehicle M.

### [Hardware Configuration]

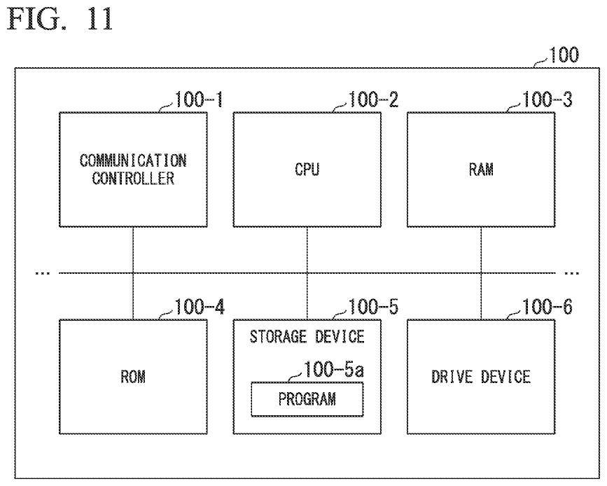

FIG. 11 is a diagram showing an example of a hardware configuration of the automated driving controller 100 according to the embodiment. As shown in FIG. 11, a computer of the automated driving controller 100 has a configuration in which a communication controller 100-1, a CPU 100-2, a random access memory (RAM) 100-3 used as a working memory, a read only memory (ROM) 100-4 storing a boot program and the like, a storage device 100-5 such as a flash memory or a hard disk drive (HDD), a drive device 100-6, and the like are mutually connected by an internal bus or a dedicated communication line. The communication controller 100-1 communicates with components other than the automated driving controller 100. A portable storage medium such as an optical disc (for example, a computer-readable non-transitory storage medium) is mounted in the drive device 100-6. The storage device 100-5 stores a program 100-5a to be executed by the CPU 100-2. This program is loaded into the RAM 100-3 by a direct memory access (DMA) controller (not shown) or the like and executed by the CPU 100-2. The program 100-5a, which is referred to by the CPU 100-2, may be stored in the portable storage medium mounted in the drive device 100-6 or may be downloaded from another device via a network. Thereby, some or all of components of the automated driving controller 100 are implemented. The hardware shown in FIG. 11 can be similarly applied to the driving assistance device 110 instead of the automated driving controller 100.

The embodiment described above can be represented as follows.

A vehicle control device including:

a storage device storing a program; and

a hardware processor,

wherein the hardware processor executes the program stored in the storage device to:

recognize surroundings of a host vehicle;

execute first avoidance control for avoiding contact with a recognized physical object according to braking of the host vehicle and second avoidance control for avoiding the contact with the physical object according to movement of the host vehicle in a vehicle width direction; and

preferentially execute either the first avoidance control or the second avoidance control on the basis of a recognized lane type of a host vehicle lane when the contact between the host vehicle and the physical object is avoided.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A vehicle control device comprising:
a recognizer configured to recognize surroundings of a host vehicle; and
an avoidance controller configured to be able to execute first avoidance control for avoiding contact with a physical object recognized by the recognizer according to braking of the host vehicle and second avoidance control for avoiding the contact with the physical object recognized by the recognizer according to movement of the host vehicle in a vehicle width direction,
wherein, when the contact between the host vehicle and the physical object is avoided, the avoidance controller selects either the first avoidance control or the second avoidance control on the basis of a lane type of a host vehicle lane recognized by the recognizer and preferentially executes the selected avoidance control.

2. The vehicle control device according to claim 1, wherein the avoidance controller preferentially executes the second avoidance control when the host vehicle lane is a lane where a lane change to an adjacent lane adjacent to the host vehicle lane is possible, and preferentially executes the first avoidance control when the host vehicle lane is a lane where a lane change is prohibited, on the basis of the lane type.

3. The vehicle control device according to claim 2, wherein the avoidance controller preferentially executes the first avoidance control when the host vehicle lane is the lane where a lane change is possible and another vehicle is present in the adjacent lane to which the host vehicle moves according to the second avoidance control.

4. The vehicle control device according to claim 3, wherein the avoidance controller executes the second avoidance control when the other vehicle is at a predetermined distance or more from the host vehicle after preferentially executing the first avoidance control.

5. The vehicle control device according to claim 2, wherein the avoidance controller executes the second voidance control after executing the first avoidance control when the host vehicle lane is a lane where a lane change is prohibited and the prohibition of the lane change will be lifted in the near future.

6. The vehicle control device according to claim 2, wherein the avoidance controller preferentially executes the first avoidance control when the host vehicle lane is the lane where a lane change is possible and will change to a lane where a lane change is prohibited in the near future.

7. A vehicle control method comprising:
recognizing, by a computer, surroundings of a host vehicle;
executing, by the computer, first avoidance control for avoiding contact with a recognized physical object according to braking of the host vehicle and second avoidance control for avoiding the contact with the physical object according to movement of the host vehicle in a vehicle width direction; and
selecting, by the computer, either the first avoidance control or the second avoidance control on the basis of a recognized lane type of a host vehicle lane when the contact between the host vehicle and the physical object is avoided and preferentially executing the selected avoidance control.

8. A computer-readable non-transitory storage medium storing a program for causing a computer to:
recognize surroundings of a host vehicle;
execute first avoidance control for avoiding contact with a recognized physical object according to braking of the host vehicle and second avoidance control for avoiding the contact with the physical object according to movement of the host vehicle in a vehicle width direction; and
select either the first avoidance control or the second avoidance control on the basis of a recognized lane type of a host vehicle lane when the contact between the host vehicle and the physical object is avoided and preferentially execute the selected avoidance control.
